(19) United States
(12) Patent Application Publication
(10) Pub. No.: US 2001/0015964 A1
(43) Pub. Date: Aug. 23, 2001

(54) Mobile phone system and handover method

(76) Inventor: Takashi Fuchisawa, Shizuoka (JP)

Correspondence Address: SUGHRUE, MION, ZINN, MACPEAK & SEAS, 2100 Pennsylvania Avenue, N.W., Washington, DC, 20037, US

(21) Appl. No.: 09/781,250

(22) Filed: Feb. 13, 2001

(30) Foreign Application Priority Data
Feb. 17, 2000 (JP) 2000-039052

(51) Int. Cl. H04Q 7/00

(52) U.S. Cl. 370/332; 370/331

(57) ABSTRACT

In a mobile phone system including plural base stations for transmitting logical control channel signals through transmission slots to which the same slot number in one frame is allocated, and a mobile phone for receiving the logical control channel signals through a reception slot to which the slot number corresponding to the transmission slots having the same slot number in the one frame is allocated, according to a handover method, each of the base stations transmits the logical control signal through the transmission slot to which the sane slot number in the one frame is allocated, and the mobile phone sets to a receivable state the reception slot to which the slot number corresponding to that of the transmission slot used when each of the plural base stations transmits the logical control channel is allocated, whereby the logical channel signal is received through the reception slot which is set to the receivable state, thereby performing handover.

### BACKGROUND OF THE INVENTION

1. Field of the Invention

The present invention relates to a mobile phone system such as a cellular phone (portable telephone) system and a car phone including plural base stations for transmitting logical control channel signals through transmission slots to which the same slot number in a frame is allocated, and a mobile phone (such as a cellular phone (portable telephone) and a car phone) for receiving a logical control channel signal through a reception slot to which the slot number corresponding to the slot number allocated to the transmission slots is allocated, and a handover method for the mobile phone system.

2. Description of the Related Art

Digitalization of a mobile phone system such as cellular phone (portable telephone) system and a car phone system has been recently promoted. The mobile system adopts a TDMA/TDD (Time Division Multiple Access/Time Division Duplex) system in which plural radio (wireless) base stations communicate with plural mobile phones while time-dividing one frequency, thereby performing a bi-directional data transmission on a pair of transmission paths. This TDMA/TDD system is also used for mobile phones such as PHS (Personal Handyphone System), DECT (Digital European Cordless Telephone). Further, it is used for PDC (Personal Digital Cellular), IS-54 (Interim Standard-54), IS-136 (Interim Standard-136) and GSM (Global System for Mobile Communication) as a TDMA system.

FIG. 1 is a diagram showing the construction of a conventional mobile phone system.

In this case, mobile phone 105 and radio base stations A 101 to D 104 connected to exchange (base station) 100 are shown. Areas 101′ to 104′ surrounded by broken lines with the radio base stations A 101 to D 104 located at the centers of the respective areas represent radio zones in which the mobile phone 105 can receive/transmit various data such as audio data and video data from/to each of the radio base stations A 101 to D 104.

In FIG. 2, (a) shows the construction of a TDMA frame used in each of the radio base stations A 101 to D 104, and also the operation of receiving/transmitting an information channel signal between the radio base station A 101 and the mobile phone 105. Further, in FIG. 2, (b) shows the construction of a TDMA frame used in the mobile phone 105 and also shows the operation when a logical control channel signal is transmitted from the radio base station B 102 and then it is received by the mobile phone 105.

In (a) and (b) of FIG. 2, four-channel TDMA frames are illustrated, and each of the TDMA frames is provided with transmission slots and reception slots. As described later, transmission/reception of the information channel signals and transmission of the logical control channel signals are performed by using a plurality of the transmission slots and reception slots.

Next, the operation of the mobile phone 105, the radio base station A 101 and the radio base station B 102 will be described.

It is assumed that the mobile phone 105 is located in the radio zone 101′ of the radio base station A 101 as shown in FIG. 1. When the radio base station A 101 transmits an information channel signal to the mobile phone 105 by using a transmission slot 3 at period t as shown in (a) of FIG. 2, the mobile phone 105 receives the information channel signal from the radio base station A 101 at the corresponding period t1 by using a reception slot 3.

Further, when returning an information channel signal in response to the information channel signal received, the mobile phone 105 returns the information channel signal at period t2 by using a transmission slot 3. At the radio base station A 101, the information channel signal thus returned is received at period t2 by using a reception slot 3. Through this operation, the information can be mutually communicated between the mobile phone 105 and the radio base station A 101.

Subsequently, when the mobile phone 105 is moved from the radio zone 101′ of the radio base station A 101 to the radio zone of another radio base station (for example, the radio zone 102′ of the radio base station B 102), the reception level of the information channel signal which is transmitted from the radio base station A 101 and received by the mobile phone 105 is degraded and the reception quality is also degraded.

Therefore, the mobile phone 105 carries out a so-called handover operation to switch the connection destination of the radio base station from/to which audio information, image information, or the like is received/transmitted while transmitting/receiving the information channel signal to/from the radio base station A 101 by using the reception slot 3 and the transmission slot 3. This is because if the mobile phone 105 stops the transmission/reception of the information channel signal to/from the radio base station A 101, the handover operation cannot be smoothly performed.

Here, each of the radio base stations A 101 to D 104 transmits a logical control channel signal by using a transmission slot to which any predetermined one of slot numbers allocated to the transmission slots 1 to 4 is allocated. The transmission timing of the logical control channel signal is staggered at fixed time intervals among the respective radio base stations A 101 to D 104.

Specifically, as shown in FIGS. 3A to 3C, for example, the radio base station B 102 transmits a logical control channel signal by using a transmission slot 4 (FIG. 3A), the radio base station C 103 transmits a logical control channel signal by using a transmission slot 1 (FIG. 3B), and the radio base station D 104 transmits a logical control channel signal by using a transmission slot 2 (FIG. 3C).

Therefore, when the mobile phone 105 carries out the handover, the mobile phone 105 sets all the reception slots to the reception mode so that it can receive any one of the logical control channel signals from the radio base stations B 102 to D 104 by using any one of the reception slots 1 to 4 as shown in (b) of FIG. 2.

The mobile phone 105 selects the radio base station transmitting the logical control channel signal having the highest reception level from the radio base stations B 102 to D 104. Therefore, it is synchronized with the slot to which the slot number specified by the radio base station concerned is allocated, and switches the radio base station to/from which the mobile phone 105 transmits/receives the information channel signal.

That is, for example in the case where the mobile phone 105 moves from the radio zone 101′ of the radio base station A 101 to the radio zone 102′ of the radio base station B 102, if the logical control channel signal transmitted from the radio base station B 102, for example, has the highest reception level among the logical control channel signals transmitted from the radio base stations B 102 to D 104, by receiving the logical control channel signal from the radio base station B 102, the mobile phone 105 specifies the slot through which the information channel signal is communicated (transmitted/received) between the radio base station B 102 and the mobile phone 105, and switches the radio base station with which the information channel signal is actually communicated, from the radio base station A 101 to the radio base station B 102.

As described above, when the mobile phone 105 carries out the handover, under the state that it is transmitting/receiving the information channel signal to/from the radio base station A 101, the mobile phone 105 receives the logical control channel signal from another radio base station B 102 to check whether it can transmit/receive the information channel signal to/from the other radio base station, specifies/tunes the slot number and then carries out the handover.

In the conventional mobile phone system described above, however, when the mobile phone is about to carry out the handover, at the mobile phone side, it cannot be specified which transmission slot is used by each radio base station to transmit the logical control channel signal. Therefore, all the reception slots are set to reception mode at the mobile phone side so as to receive the logical control channel signals from all the radio base stations. Therefore, much power is consumed every time the handover is carried out at the mobile phone side.

Further, when the handover is carried out in the conventional mobile phone system, under the state that the mobile phone transmits/receives the information channel signal to/from a radio base station, it must receive the logical control channel signal transmitted from another radio base station. Therefore, if the transmission slot used by a radio base station serving as a handover source (that is, a radio base station which communicates with a mobile phone just before handover) is coincident with the transmission slot through which a radio base station serving as a handover destination (that is, a radio base station which will communicate with the mobile phone just after handover) transmits a logical control channel signal, the mobile phone could not receive the logical control channel signal. Therefore, there may occur a case where a ratio base station to which the connection destination is switched through the handover is not best for the mobile phone.

### SUMMARY OF THE INVENTION

Therefore, an object of the present invention is to reduce the power consumption of a mobile phone and enable the mobile phone to connect to the best radio base station for the mobile phone when handover is carried out.

In order to attain the above object, according to the present invention, there is provided a mobile phone system comprising plural base stations each transmitting a logical control channel signal through a transmission slot to which the same slot number in a frame is allocated, and a mobile phone receiving the transmitted logical control channel signal through a reception slot to which the slot number corresponding to the transmission slot is allocated and setting the reception slot into a receivable state, whereby the mobile phone receives the logical control channel signal by the reception slot which are set into the receivable state when handover is carried out.

Further, according to the present invention, there is provided a handover method for a mobile phone system comprising transmitting logical control channel signals from plural base stations through transmission slots to which the same slot number in one frame is allocated, receiving the logical control channel signals at a mobile phone through a reception slot to which the slot number corresponding to the transmission slot is allocated, and setting into a receivable state the reception slot for carrying out handover.

### BRIEF DESCRIPTION OF THE DRAWINGS

FIG. 1 is a diagram showing the construction of a conventional mobile phone system;

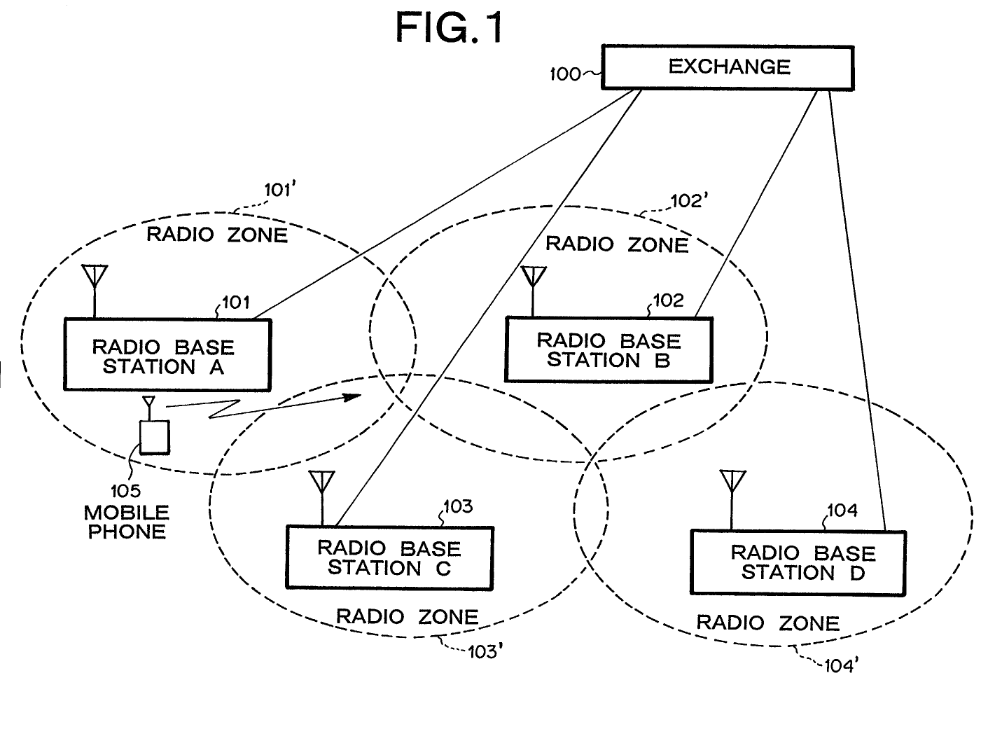

FIG. 2 is a diagram showing the construction of a TDMA frame and a diagram showing the operation of transmitting/receiving signals between radio base station A 101 and mobile phone 105;

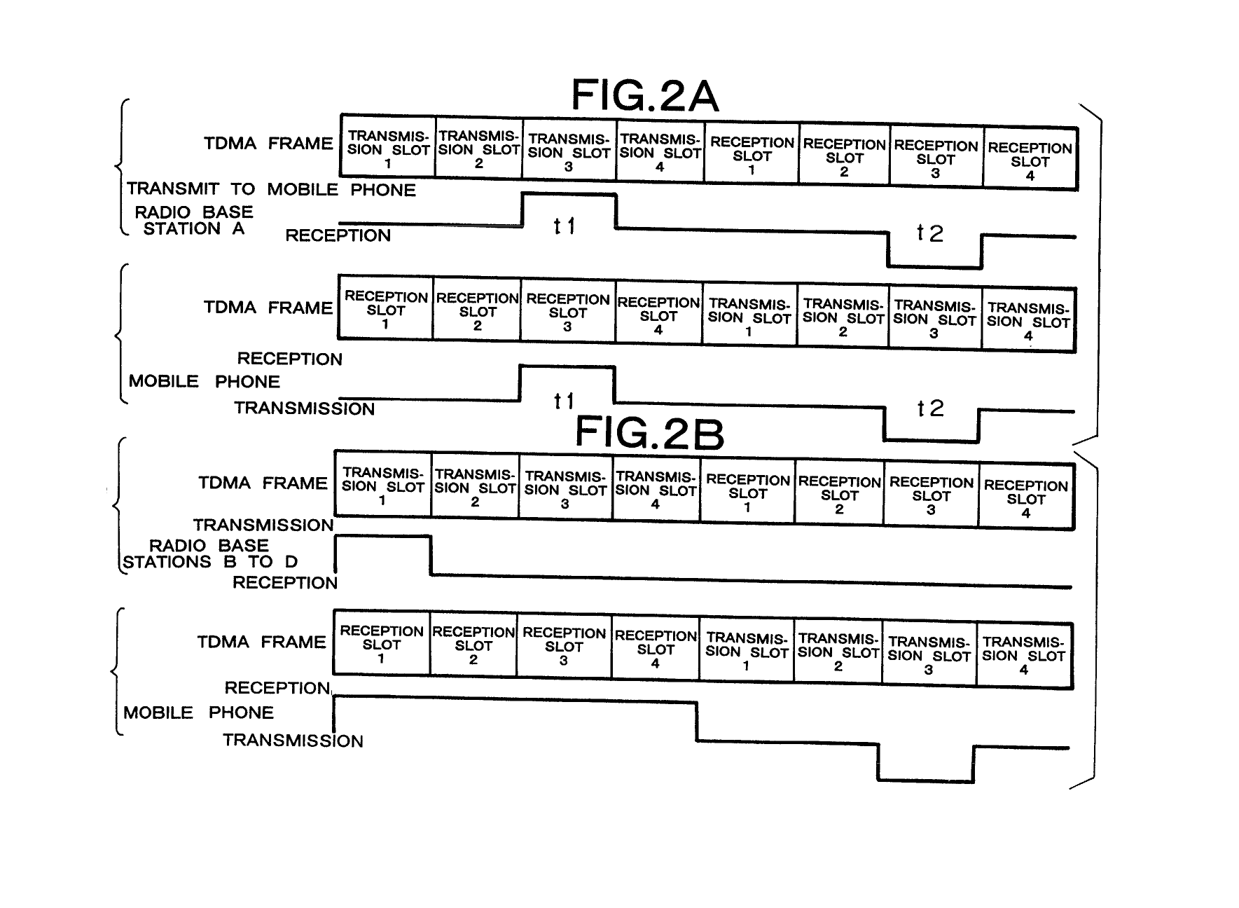

FIG. 3 is a diagram showing a state that a logical control channel signal is transmitted from each of the radio base stations B to D;

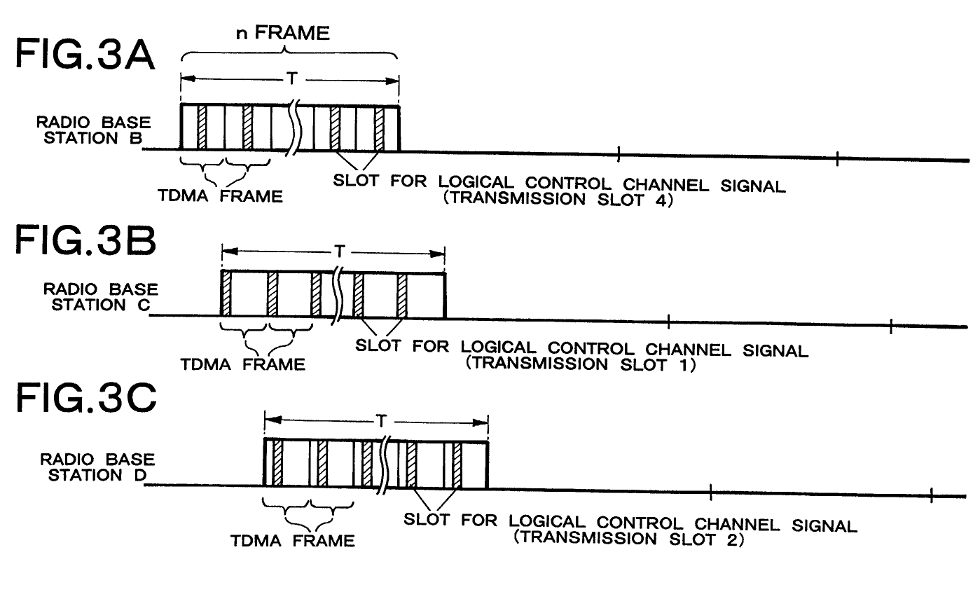

FIG. 4 is a diagram showing the construction of a mobile phone system according to an embodiment of the present invention;

FIG. 5 is a diagram showing the construction of a TDMA frame used when data are transmitted/received (communicated) between each of radio base stations A to D and mobile phone 105 of FIG. 4;

FIG. 6 is a timing chart showing a timing at which a logical control channel signal is transmitted from each of the radio base stations B to D; and

FIG. 7 is a diagram showing a signal transmission/reception (communication) timing between each of the radio base stations A to D and the mobile phone.

### DETAILED DESCRIPTION OF THE PREFERRED EMBODIMENTS

Preferred embodiments according to the present invention will be described hereunder with reference to the accompanying drawings.

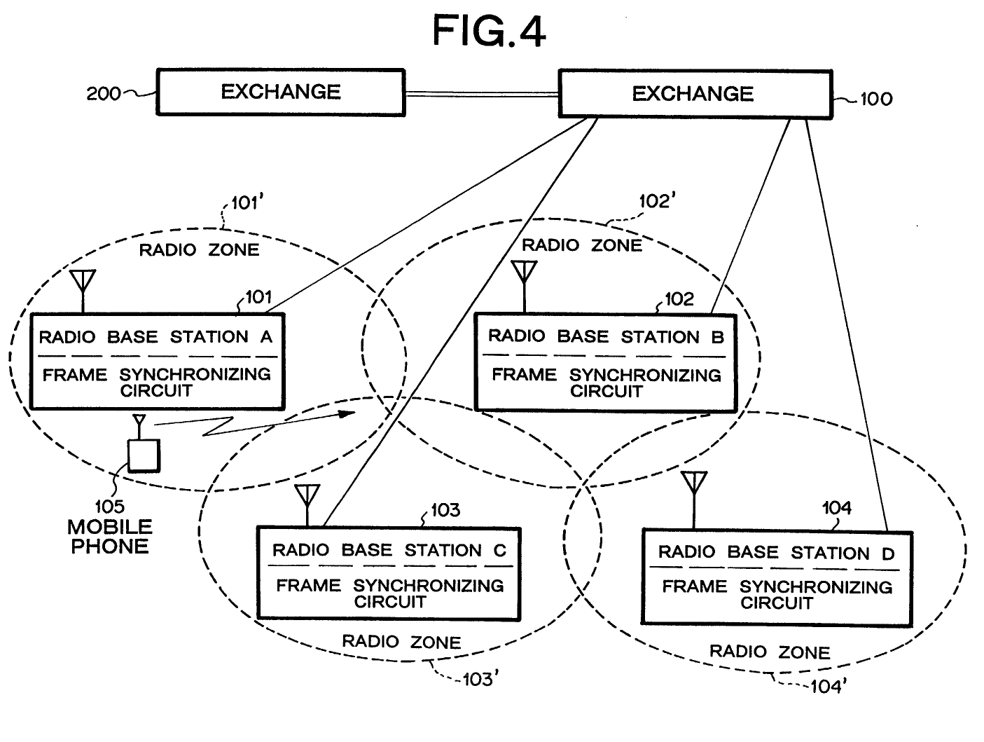

FIG. 4 is a diagram showing the construction of a mobile phone system according to an embodiment of the present invention.

The mobile phone system (such as a cellular phone (portable telephone) system and a car phone) shown in FIG. 4 includes radio base station A 101 having radio zone 101′, radio base station B 102 having radio zone 102′, radio base station C 103 having radio zone 103′, radio base station D 104 having radio zone 104′, exchange 100 which are connected to plural base stations containing the radio base stations A 101 to D 104 and relay exchanges through wires, exchange 200 which is connected to the exchange 100 through a public line such as an ISDN (Integrated Services Digital Network) line or the like, and mobile phone (such as cellular phone (portable telephone) and car phone) 105 for transmitting/receiving data to/from each of the radio base stations A 101 to D 104. Each of the radio base stations A 101 to D 104 shown in FIG. 4 has a frame synchronizing circuit for synchronizing to a frame to be transmitted to the mobile phone 105.

For example when the mobile phone 105 is located in the radio zone 101′, it can transmit/receive information such as audio information and image information to/from the radio base station A 101 in the TDMA/TDD system. Likewise, when it is located in each of the radio zones 102′ to 104′, it can transmit/receive information such as audio information and image information to/from each of the radio base stations B 102 to D 104 in the TDMA/TDD system.

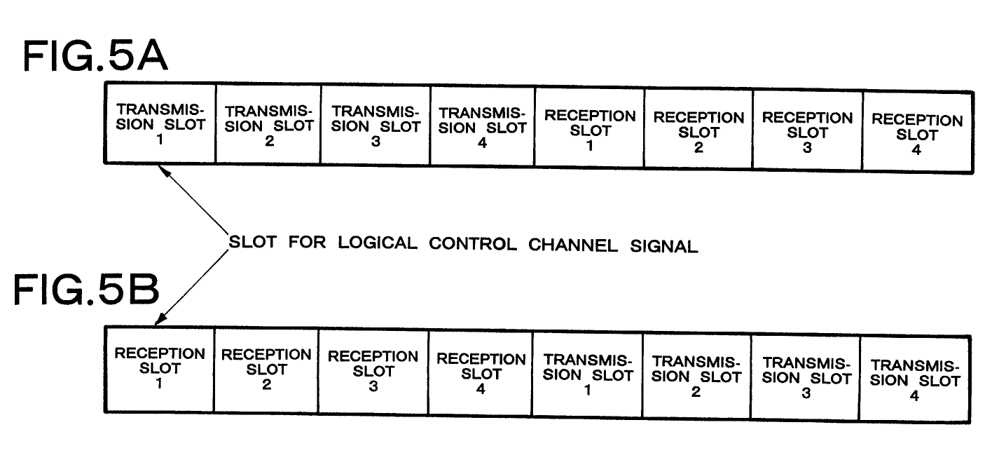

FIG. 5A is a diagram showing the construction of a TDMA frame having transmission slots and reception slots used when each of the radio base stations A 101 to D 104 transmit/receive data to/from the mobile phone 105. FIG. 5B is a diagram showing the construction of a TDMA frame having transmission slots and reception slots used when the mobile phone 105 transmits/receives data to/from each of the radio base stations A 101 to D 104. In this case, it is illustrated that every four transmission slots and every four reception slots constitute one radio-frequency TDMA frame.

Here, it is assumed that a logical control channel signal is transmitted by using a transmission slot 1 in the radio base stations A 101 to D 104. Further, the information channel signal is transmitted/received between each of the radio base stations A 101 to D 104 and the mobile phone 105 by using any one of the transmission slots 2 to 4 and any one of the reception slots 2 to 4.

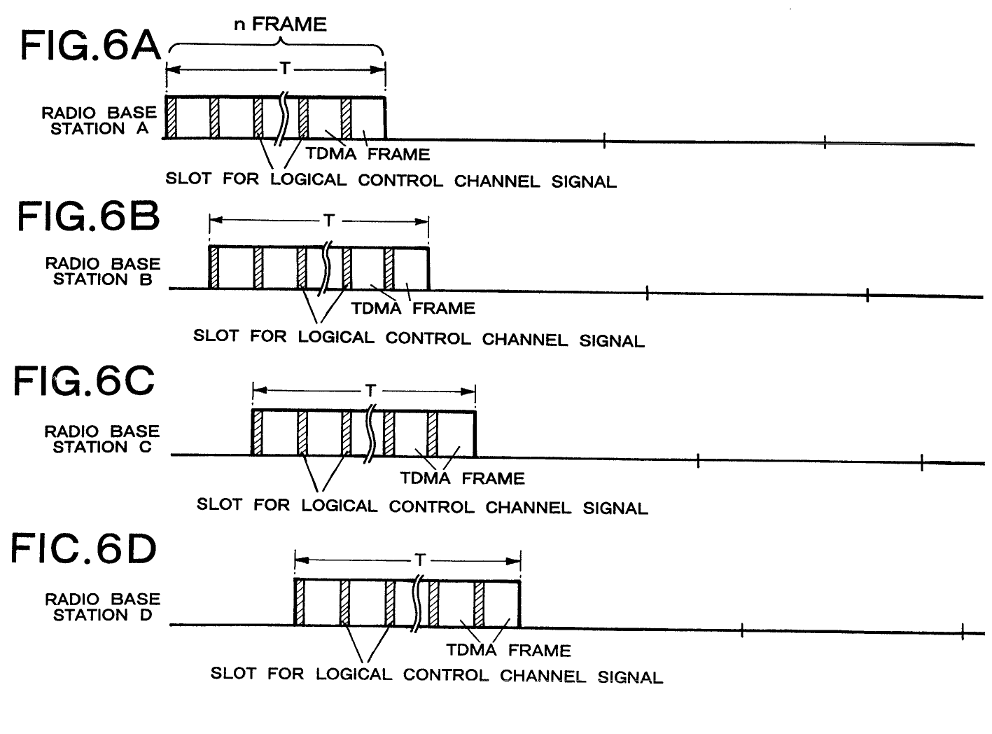

FIGS. 6A to 6D are timing charts showing the timing at which a logical control channel signal is transmitted from each of the radio base stations A 101 to D 104. As described above, each of the radio base stations B 102 to D 104 transmits the logical control channel signal by using the transmission slot 1, for example. Further, the radio base stations B 102 to D 104 transmit logical control channel signals that are multiplexed by using n (n represents natural number) frames at the same period T. The transmission period T is set to an integral multiple of the TDMA frame, and the respective frames are transmitted at the same period, but at different frequencies.

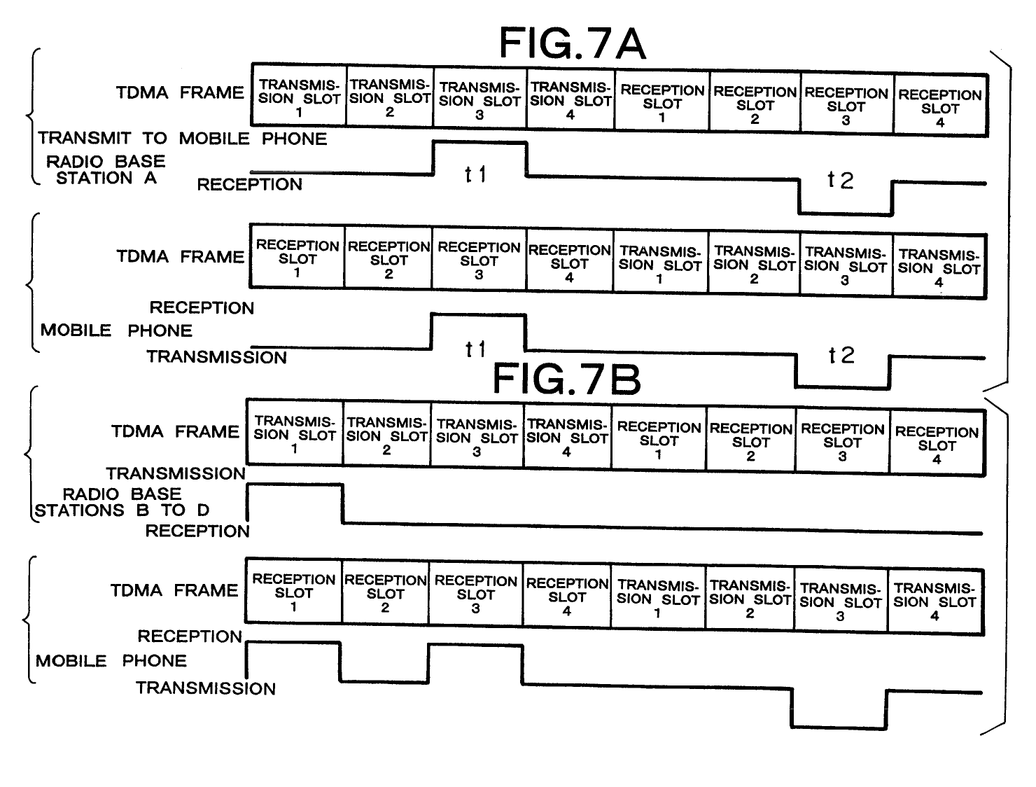

In FIG. 7, (a) shows the transmission/reception timing of the information channel signal between the radio base station A 101 and the mobile phone 105, and in FIG. 7, (b) shows the timing at which the logical control channel signal is transmitted from each of the radio base stations B 102 to D 104 and the signal transmission/reception timing at the mobile phone 105 which is about to carry out the handover.

Next, the operation of the mobile phone system according to this embodiment will be described.

First, it is assumed that the mobile phone 105 is located in the radio zone 101′ of the radio base station A 101 as shown in FIG. 4. When the radio base station A 101 specifies the address of the mobile phone 105 and transmits an information channel signal to the mobile phone 105 at period t1 by using the transmission slot 3 as shown in (a) of FIG. 7, the information channel signal transmitted from the radio base station A 101 is received by the mobile phone 105, for example at period t1 by using the reception slot 3.

Further, when the mobile phone 105 returns an information channel signal in response to the information channel signal thus received, it transmits the information channel signal at period t2 by using the transmission slot 3 corresponding to the transmission slot which is being transmitted from the radio base station A 101, and the radio base station A 101 receives the information channel signal at period t2 by using the reception slot 3.

Subsequently, when the mobile phone 105 is moved from the radio zone 101′ of the radio base station A 101 to the radio zone 102′ of another radio base station such as the radio base station B 102 as indicated by an arrow of FIG. 4 because the user of the mobile phone 105 moves or the like, the reception level or degradation of reception quality of the information channel signal which is transmitted from the radio base station A 101 and received by the mobile phone 105 is judged by comparing it with a threshold value of the reception level for example.

Therefore, the mobile phone 105 sets the reception slot 1 to a signal receivable state to receive the logical control channel signal from each of the radio base stations A 101 to D 104 while transmitting/receiving the information channel signal to/from the radio base station A 101 by using the reception slot 3 and the transmission slot 3 as shown in (b) of FIG. 7.

Here, each of the radio base stations A 101 to D 104 transmits the logical control channel signal by using the transmission slot 1 at such a timing that the frame period thereof is staggered from those of the other radio base stations at fixed time intervals as shown in FIGS. 6A to 6D. Therefore, when the mobile phone 105 is about to carry out the handover, it is allowed to receive the logical control channel signal from each of the radio base stations such as the radio base stations B 102 to D 104 by using the reception slot 1.

When receiving the logical control channel signal from each of the radio base stations B 102 to D 104, the mobile phone 105 detects the reception level of the logical control channel signal transmitted from each of the radio base stations A 101 to D 104 by detecting means (not shown), and temporarily stores the reception level in a memory (not shown).

Thereafter, the mobile phone 105 compares the reception level of each logical control channel signal thus detected with the reception level of the information channel signal transmitted/received to/from the radio base station A 101. If the reception level of each of the logical control channel signals transmitted from the other radio base stations B 102 to D 104 is higher than the reception level of the information channel signal received from the radio base station A 101, the mobile phone 105 tune itself to the radio base station transmitting the logical control channel signal having the highest reception level, and switches the ration base station for the transmission/reception of the information channel signal on the basis of an instruction from the radio base station concerned.

That is, for example when the mobile phone 105 is moved to the radio zone 102′ of the radio base station B 102, the logical control channel signal transmitted from the radio base station B 102 is highest in reception level among the logical control channel signals transmitted from the radio base stations B 102 to D 104. Therefore, the radio base station to/from which the information channel signal is transmitted/received through a predetermined slot is switched from the radio base station A 101 to the radio base station B 102.

As described above, according to this embodiment, each of the radio base stations A 101 to D 104 settles the transmission slot 1 as a transmission slot through which the logical control channel signal is transmitted. Therefore, when the handover is carried out, it is necessary for the mobile phone 105 to do nothing but set the reception slot 1 to the signal receivable state. Therefore, only the thing required to the mobile phone 105 is to receive all the logical control channel signals transmitted from the radio base stations B 102 to D 104 only once with no error. Accordingly, it is unnecessary to search the radio base stations while continuously keeping the signal receivable state, and thus the signal reception can be performed with small power consumption.

If the number of radio base stations connected to one exchange is increased, it would be necessary to quicken the transmission timing of the logical control channel signal transmitted from each radio base station as shown in FIGS. 6A to 6D. However, the quickening of the timing has the upper limit. Therefore, in this case, if the logical control channel signal is transmitted by the transmission slot 1 serving as the special-purpose slot for transmitting the logical control channel signal, the number of radio base stations which can serve as handover destinations is reduce. Therefore, this is unfavorable.

Therefore, when the number of radio base stations connected to one exchange is very large, information as to whether each of the radio base stations connected to the exchange is provided with a special-purpose slot for transmitting a logical control channel signal, that is, whether the logical control channel is transmitted through any transmission slot is transmitted while added to the logical control channel signal.

In this case, in the case where the mobile phone 105 receives a logical control channel signal from a radio base station other than the radio base station which actually transmits/receives an information channel signal, if the logical control channel signal is added with information as to whether the logical control channel is transmitted through any transmission slot, the mobile phone 105 stores into a memory the fact that the reception slot for the logical control channel signal is the reception slot 1, and also it sets to the signal receivable state the reception slots other than the reception slot through which the information signal is transmitted/received with the radio base station serving as the handover source, whereby the number of receivable logical control channel signals is increased and a radio base station serving as a handover destination is selected. This operation makes the radio base station serving as the handover destination best for the mobile phone 105. Therefore, the mobile phone 105 can transmit/receive the information channel signal to/from the radio base station serving as the best handover destination.

As described above, according to the present invention, the respective plural base stations transmit the logical control channel signals through transmission slots to which the same slot number in one frame is allocated, and the mobile phone receives the logical control channel signals through the reception slot to which the slot number corresponding to the same slot number of the transmission slots is allocated. Therefore, the mobile phone can receive the logical control channel signal without failing in searching the control channel signal of the handover destination. Therefore, the power consumption of the mobile phone can be reduced, and the mobile phone can be connected to the best base station for the mobile phone when handover is carried out.

What is claimed is:

1. A mobile phone system comprising:
plural base stations each transmitting a logical control channel signal through a transmission slot to which the same slot number in a frame is allocated, and
a mobile phone receiving the transmitted logical control channel signal through a reception slot to which the slot number corresponding to the transmission slot is allocated and setting the reception slot into a receivable state, whereby said mobile phone receives the logical control channel signal by the reception slot which are set into the receivable state when handover is carried out.

2. The mobile phone system as claimed in claim 1, wherein when receiving the logical control channel signal through the reception slot which is set to the receivable state, said mobile phone sets into a receivable state an other reception slot which is not used for communications between said mobile phone and one base station of said plural base stations serving as a handover source.

3. The mobile phone system as claimed in claim 1, wherein the logical control channel signal is successively transmitted at a fixed period timing from each of said plural base stations.

4. The mobile phone system as claimed in claim 1, wherein the logical control channel signal transmitted from each of said plural base stations is synchronized in transmission timing among said plural base stations.

5. The mobile phone system as claimed in claim 3, wherein the logical control channel signal transmitted from each of said plural base stations is synchronized in transmission timing among said plural base stations.

6. The mobile phone system as claimed in claim 2, wherein said mobile phone detects a reception level of each of logical control channel signals thus received, and compares the reception level of the logical control channel signal thus detected with the reception level of an information channel signal which is transmitted/received to/from said one base station serving as said handover source.

7. A handover method for a mobile phone system comprising:
transmitting logical control channel signals from plural base stations through transmission slots to which the same slot number in one frame is allocated,
receiving the logical control channel signals at a mobile phone through a reception slot to which the slot number corresponding to the transmission slot is allocated, and
setting into a receivable state the reception slot for carrying out handover.
